(19) United States
(12) Patent Application Publication
(10) Pub. No.: US 2010/0161734 A1
(43) Pub. Date: Jun. 24, 2010

(54) DETERMINING SPAM BASED ON PRIMARY AND SECONDARY EMAIL ADDRESSES OF A USER

(75) Inventor: Tak Yin Wang, Los Altos, CA (US)

Correspondence Address: Yahoo! Inc.;c/o Frommer Lawrence & Haug LLP, 745 Fifth Avenue, NEW YORK, NY, 10151, US

(73) Assignee: Yahoo! Inc., Sunnyvale, CA (US)

(21) Appl. No.: 12/341,323

(22) Filed: Dec. 22, 2008

(51) Int. Cl. G06F 15/82

(52) U.S. Cl. 709/206

(57) ABSTRACT

Embodiments are directed towards identifying a message as spam or non-spam based on a number of messages in given category or combination of categories that exceed at least one threshold. As messages are received at a network device, they may be examined, and categorized. Various counts for each of the categories and/or combinations of categories may then be compared to various respective thresholds. If a threshold is exceeded for a given message, the message may be defined as a spam. In one embodiment, such classification of messages sent by that message sender address may be blocked from being delivered. In another embodiment, such classification of messages having substantially similar content independent of having the same message sender address may be blocked from being delivered.

### TECHNICAL FIELD

The embodiments relate generally to managing messages over a network and, more particularly, but not exclusively to employing multiple email addresses in combination with a white list for a user to detect spam messages.

### BACKGROUND

The problem of spam is well recognized in established communication technologies, such as electronic mail. Spam may include unsolicited messages sent by a computer over a network to a large number of recipients. Spam includes unsolicited commercial messages, but spam has come to be understood more broadly to additionally include unsolicited messages sent to a large number of recipients, and/or to a targeted user or targeted domain, for malicious, disruptive, or abusive purposes, regardless of commercial content. For example, a spammer might send messages in bulk to a particular user to harass, or otherwise, disrupt their computing resources.

A typical approach to managing spam is to employ a whitelist. Within the context of messaging, a whitelist provides a list of senders, sender addresses, sender domains, or other sending entities for which a message is to be accepted. In that sense, a whitelist may be viewed as being an inclusionary list indicating that a message from an entity on the list is to be allowed to be sent to the recipient. However, while whitelists provide some level of protection, they must be maintained. For example, consider that a first person meets a second person at some social event. The first person offers to receive an email message from the second person. However, if the second person is not on the first person's whitelist, the first person will be unable to receive the message, at least not until the whitelist is updated. If the first person failed to obtain sufficient information about the second person, then updating the whitelist to allow messages from the second person may not be readily possible. Moreover, if the second person attempts to send a message to the first person before the whitelist is updated, then the first person will not get the message. This could result in the second person believing that the first person had not intended to receive messages. Such a non-limiting, non-exhaustive scenario could then result in social opportunities being lost, business opportunities being lost, or the like.

An alternative to whitelists that is often used are known as blacklists. A blacklist as used within the context of messaging excludes messages from being received from selective entities. While this approach may have the benefit of allowing the first person in the above scenario to receive a message from the second person, blacklists tend to allow more spam to be delivered to the recipients. Thus, a user of blacklists must also continually manage their blacklists. Managing of such lists, white or black, often results in frustration by the user. Therefore, many of the lists are simply not updated. This often means that the use of such lists becomes less useful. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which embodiments of the invention may be practiced;

FIG. 2 shows one embodiment of a client device that may be included in a system implementing embodiments of the invention;

FIG. 3 shows one embodiment of a network device that may be included in a system implementing embodiments of the invention;

FIG. 4 illustrates a logical flow diagram generally showing one embodiment of a process for employing primary and secondary message addresses in combination with a white list for a user to detect spam messages; and

FIG. 5 illustrates a logical flow diagram generally showing one embodiment of a process for determining how to route a message to one of a primary or secondary message address.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, embodiments are directed towards managing spam messages across a community of message recipients by identifying a message as spam or non-spam based on a number of messages in given category or combination of categories defined, in part, on how the message is evaluated. Recipients of messages are allowed to manage a primary message address and a secondary message address for receiving messages. A primary message address may be defined, herein as a primary account recipient address for which the user defines for receiving messages. It is recognized that a message recipient may employ multiple primary accounts or primary message addresses to receive messages. For example, a message recipient might have a work message account, a home message account, as well as others. As used herein, a secondary message address or secondary account refers to another message address that is associated with the primary message address. In one embodiment, the secondary message address, however, is not subjected to a same set of filtering rules as the primary message address. However, as configured, the messages sent to the secondary message address may be received into a same email inbox, folder, or other mechanism, as that of the primary message address.

In general, virtually any message address structure may be used as a secondary message address, including, but not limited to a virtual message address, for example. It may be desirable, however, for network routing reasons, to maintain the primary address and secondary message addresses to be within a same network domain. In one embodiment, a virtual subdomain may be used to create the secondary message address.

A virtual subdomain as used herein may be created, in one embodiment, by adding test of a user's choice as the subdomain of the message address to the domain address. Thus, as a non-limiting, non-exhaustive example, the text “dragon” may be used to create a virtual subdomain for the domain yahoo.com as: @dragon.yahoo.com. Therefore, a user named “Jamie” may have a primary message address of “Jamie@yahoo.com,” and a secondary message address using the virtual subdomain dragon as “Jamie.@dragon.yahoo.com.” In one embodiment, messages sent to either message address may be delivered to a same messaging inbox, folder, or the like.

In one embodiment, a user may now employ a whitelist to block unsolicited messages to their primary message address. However, a user may also select not to employ a whitelist for their primary message address. Additionally, the user may selectively provide to others the secondary message address. By protecting to whom the secondary message address is given, the user may be reasonably assured that messages sent to the secondary message address are valid messages.

Embodiments of the invention monitor for messages sent to a secondary message address and automatically add the sender's message address to the recipient's whitelist, should one be used, for their primary message address. In this manner, the recipient's whitelist is maintained for the recipient, automatically, without intervention by the recipient to perform additional actions. Additionally, embodiments track which secondary message address, if any, is used to add a message sender address to the recipient's whitelist. Moreover, the sender may now send messages to the recipient's primary and/or secondary message addresses.

Should, however, the recipient determine that the secondary message address is compromised, for example, by a spammer, the recipient can change a mode of the secondary message address from an “open mode” to a “whitelist mode”. In addition, the recipient may have the unauthorized message sender address removed from his whitelist. As used herein, the “whitelist mode” allows authorized sender addresses who have already been added to the whitelist associated with the secondary message address to continue sending messages to this secondary message address, but it does not accept new message sender addresses into the whitelist when the messages are sent to this secondary message address. By blocking new addresses, illegitimate use in the future of the secondary message address may be quickly stopped. However, unlike disposable message addresses that are closed or disposed of, secondary message addresses as used herein are retained, such that those senders previously approved to send messages may continue to send messages to the secondary message address such that the recipient may receive the messages.

Additionally, by taking advantage of the above primary and secondary message address management spammers may be more readily detected. That is, the invention discloses defining categories of message management based in part on message address types and how the messages are perceived. Thus, messages may be distinguished based on whether they are rejected due to failure to be in a whitelist for the primary message address or secondary message address. Moreover, another category of messages may be defined as those messages that are normally sent to a primary message address where a whitelist might not be employed at all.

As messages are received at a network device, they may be examined, and categorized. In one embodiment, a plurality of messages may be received for examination and/or categorization. A count of each category of messages may then be obtained. Thus, a first count, of “normal” messages, may be determined as a number of messages from a given message sender address sent to message addresses without whitelists. A second count, of “primary” messages, may be determined based on a number of messages from the message sender address that are rejected by a whitelist on a primary message address. Additionally, a third message count, of “secondary” messages, may be determined based on a number of messages from the message sender address that are rejected by a whitelist for a secondary message address.

The various counts for each of the categories and/or combinations of categories may then be compared to various respective thresholds. If a threshold is exceeded for a given message sender address, the message sender address may be defined as a spammer. In addition to the message sender address, if a threshold is exceeded for the message content that embodiments deem similar may also be defined as spam messages regardless of the message sender address used. In that way, should a spammer attempt to send similar message content using different message sender addresses, the content may still be detected as spam.

Additionally, in one embodiment, messages from the message sender address may be labeled as spam. In one embodiment, such classification of a message sender address and messages sent by that message sender address may be blocked from being delivered. In another embodiment, other messages with content determined to be similar to content labeled as spam may also be labeled as spam and such classification of the other messages and subsequent similar messages may be blocked from being delivered. In another embodiment, a message labeled as spam might still be delivered to a message recipient. Should a number of message recipients reclassify the message as non-spam the message sender address may be subsequently reclassified as well, to a non-spammer.

It should be noted that while embodiments of the invention may be directed towards email messages, the invention is not so limited. Thus, in another embodiment other types of messages and message sender addresses may be classified, including but not limited to those using Short Message Service (SMS), Multimedia Message Service (MMS), instant messaging (IM), internet relay chat (IRC), Mardam-Bey's IRC (mIRC), Jabber, or the like.

### Illustrative Operating Environment

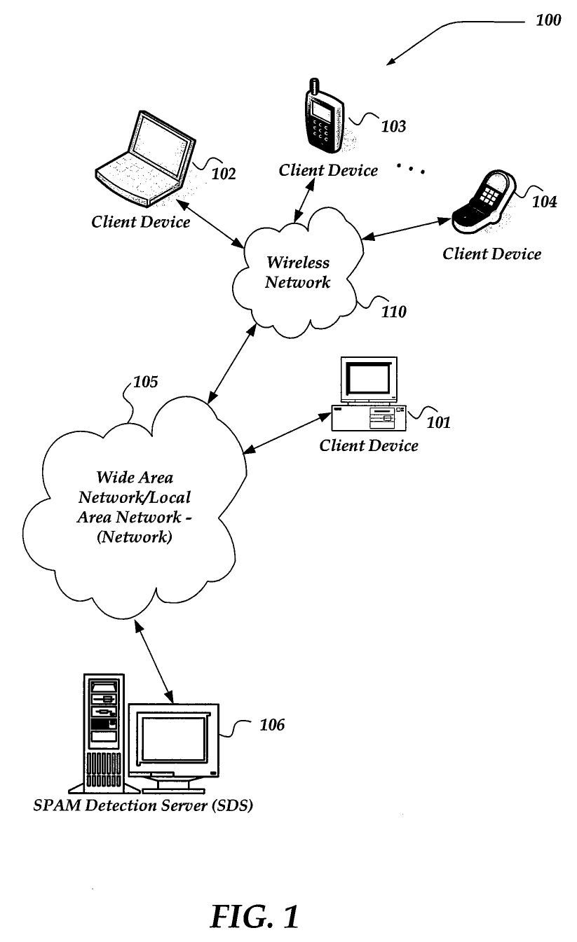

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, client devices 101-104, and Spam Detection Server (SDS) 106.

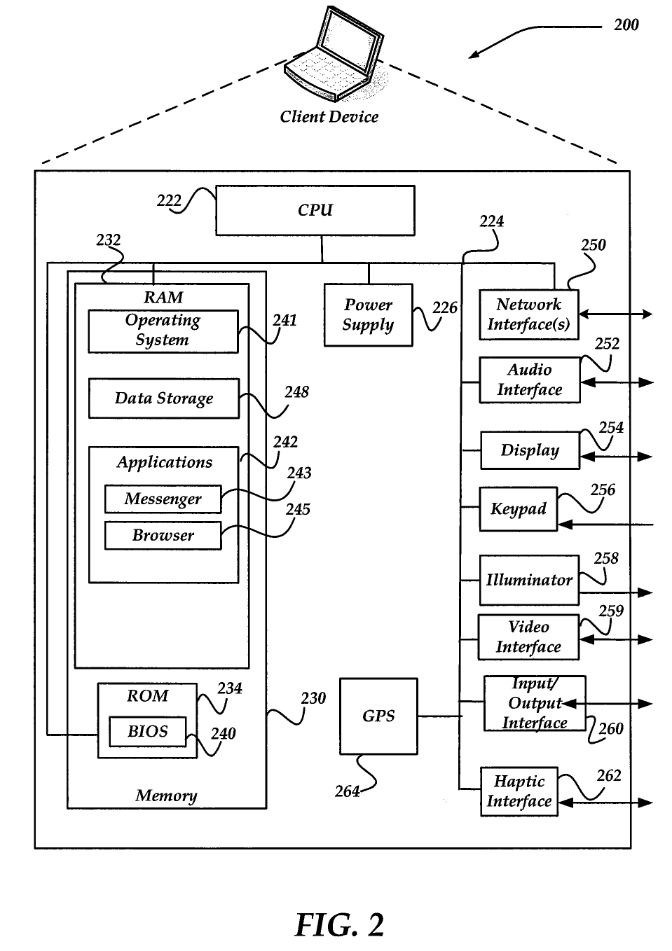

One embodiment of a client device usable as one of client devices 101-104 is described in more detail below in conjunction with FIG. 2. Generally, however, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as personal computers, multiprocessor systems, microprocessor-based or programmable consumer electronics, network PCs, or the like. In one embodiment, one or more of client devices 101-104 may also be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-104 also may include at least one other client application that is configured to receive content from another computing device. The client application may include a capability to provide and receive textual content, multimedia information, or the like. The client application may further provide information that identifies itself, including a type, capability, name, or the like. In one embodiment, client devices 101-104 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

Client devices 101-104 may also be configured to communicate a message, such as through email, SMS, MMS, IM, IRC, mIRC, Jabber, or the like, between another computing device. However, the present invention is not limited to these message protocols, and virtually any other message protocol may be employed.

Client devices 101-104 may further be configured to include a client application that enables the user to log into a user account that may be managed by another computing device, such as SDS 106, or the like. Such user account, for example, may be configured to enable the user to receive emails, send/receive IM messages, SMS messages, access selected web pages, or participate in any of a variety of other social networking activity. However, managing of messages or otherwise participating in other social activities may also be performed without logging into the user account.

A user of client devices 101-104 may employ any of a variety of client applications to access content, read web pages, receive/send messages, or the like. In one embodiment, each of client devices 101-104 may include an application, or be associated with an application that resides on the client device or another network device, that is useable to filter received messages. In one embodiment, the message filter might reside remotely on a content server (not shown), a messaging server, such as SDS 106, or the like.

In one embodiment, the message filter might include a whitelist that is configured to determine whether to allow a message from a message sender address. That is, if the message sender address is in the whitelist, then the message filter may allow messages from the message sender address to be received by the recipient client device. In one embodiment, the message filter is associated with a primary message address, as described above. In one embodiment, an inbox, folder, or other mechanism useable to receive messages may reside on SDS 106. In another embodiment, the mechanism may reside on SDS 106 and/or a component, such as a client component, message user agent (MUA), or the like, may reside on client devices 101-104.

In one embodiment, a user of client devices 101-104 may also create and use a secondary message address to receive messages. In one embodiment, the secondary message address may be created using virtual subdomains, as described above. However, the invention is not limited to using virtual subdomains, and other mechanisms, formats, structures, or the like, may be used to create a secondary message address. In one embodiment, messages sent to the secondary message address may be considered legitimate messages, such that the message may be allowed to be received into an inbox, folder, or the like. In one embodiment, messages sent to the secondary message address may be received at a same inbox, folder, or the like, as messages sent to a primary message address. In this manner, the user need not manage multiple message accounts. Moreover, because messages sent to the user's secondary message address are considered (unless “whitelist mode” is enabled) to be legitimate messages, SDS 106, and/or a client component may update one or more whitelists. That is, when a message sent to a secondary message address is received, the sender address of the message may be added to a whitelist associated with the primary message address. In one embodiment, a whitelist may also be managed for the secondary message address. If a secondary message address whitelist is managed, then the message sender may also be added to that secondary whitelist.

When the user of client devices 101-104 determines, however, that the secondary message address is compromised, perhaps, because spam is now being received at the secondary message address, the user may change the status of the secondary message address from “open” to “whitelist mode”, or a similar such status. A message sent to the secondary message address subsequent to turning on “whitelist mode” for new messages, will be examined to determine if the sender address is on the secondary whitelist and/or primary whitelist. In one embodiment, if the sender address is not on the whitelist(s), the message may be blocked from being delivered to the recipient. However, in another embodiment, the user may also select that any message sent to the secondary message address could be rejected from delivery.

At any time, the user may employ more than one (or no) secondary message addresses. In this manner, multiple whitelists might be maintained, such as one per secondary message address. However, as noted, in another embodiment, a single whitelist might be maintained that is useable for the primary message address and the one or more secondary message addresses.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple SDS 106, and client device 101 with other computing devices, including through wireless network 110 to client devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

SDS 106 represents a network computing device that is configured to manage detection of spam messages received over a network. In one embodiment, SDS 106 may include a message server that is configured to receive messages and route them to an appropriate client device, or the like. Thus, SDS 106 may include a message transfer manager to communicate a message employing any of a variety of email protocols, including, but not limited, to Simple Mail Transfer Protocol (SMTP), Post Office Protocol (POP), Internet Message Access Protocol (IMAP), Network News Transfer Protocol (NNTP), and the like. However, SDS 106 may also include a message server configured and arranged to manage other types of messages, including, but not limited to SMS, MMS, IM, or the like.

SDS 106 may further include one or more message classifiers useable to classify received messages and organize or sort them into different message folders based, in part, on the classification. Such classification may include predictions that the message is a spam message, a bulk message, a ham message, or the like. SDS 106 may then send the message to a message folder based on the classification, or block messages from being delivered to a message recipient.

SDS 106 may receive a plurality of messages from various message sender addresses. In one embodiment, the messages may be received and examined singularly. However, in another embodiment, the messages may be received several at a time. In any event, SDS 106 may then determine counts for different categories of messages. SDS 106 may employ information about whether a message is allowed to be received at a secondary message address (“open mode”), whether a message is blocked from being received at a secondary message address (“whitelist mode”), and/or whether a message is allowed to be received at a primary message address (is on a whitelist). Moreover, SDS 106 may further count a number of messages sent to valid recipients from a same message sender address. SDS 106 may then employ the various counts to determine whether a message sender address is to be identified as a spammer or not. In one embodiment, if a message sender address is identified as a spammer, messages from that message sender address may also be marked as spam. In one embodiment, messages marked as spam may be blocked from delivery to an intended recipient. However, in another embodiment, the spam marked message might still be delivered.

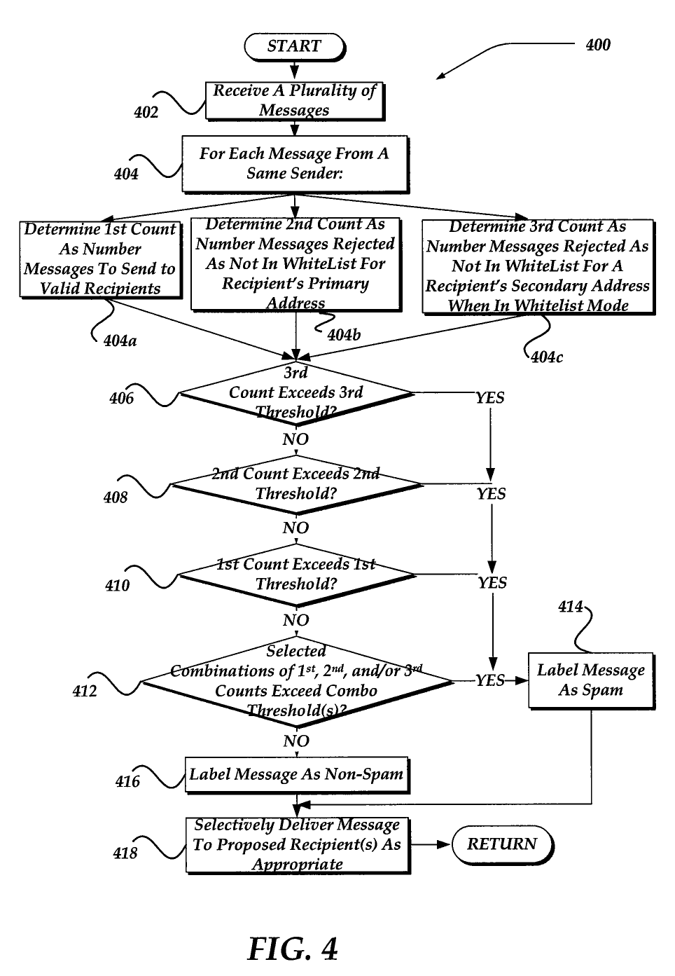

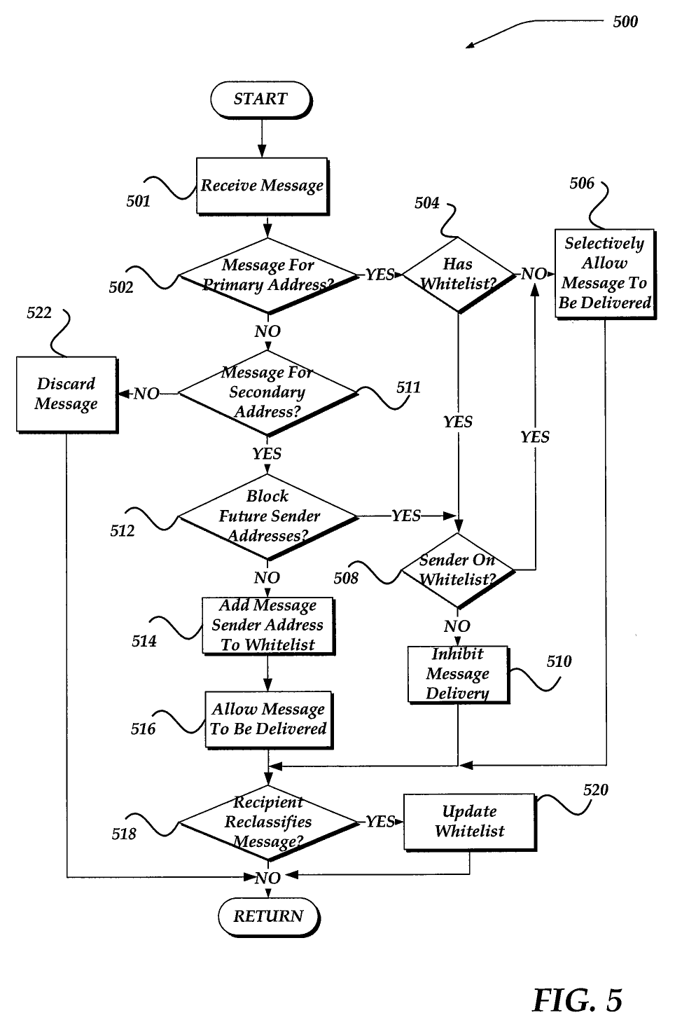

By delivering a spam marked message to the intended recipient(s), the recipient(s) may then examine the message and provide feedback. For example, if the user leaves the “spam” status of a message unchanged after reading it, such action may be determined to confirm that the message is spam. On the other hand, if the user changes the “spam” status to “non-spam” by moving the message away from a spam folder or modifying the label of the message from “spam” to other non-spam labels, then such actions may allow the message sender address to be added to the user's whitelist and thereby further improve the accuracy in the future. SDS 106 may employ a process such as described below in conjunction with FIG. 4 to perform at some of its actions. Moreover, SDS 106 may further employ a process such as described below in conjunction with FIG. 5 to perform at least some other actions.

Devices that may operate as SDS 106 include, but are not limited to personal computers, desktop computers, multiprocessor systems, microprocessor-based or programmable consumer electronics, network PCs, servers, network appliances, and the like.

Although SDS 106 is illustrated as a distinct network device, the invention is not so limited. For example, a plurality of network devices may be configured to perform the operational aspects of SDS 106. For example, in one embodiment, the message classification may be performed within one or more network devices, while the message server aspects useable to route messages may be performed within one or more other network devices.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-104 of FIG. 1.

As shown in the figure, client device 200 includes a processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, r any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. In addition, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, data files, graphs, videos, or the like. Data storage 248 may further provide storage for user account information useable with one or more message addresses, message folders, or the like. Thus, data storage 248 may include various message storage capabilities to store and/or otherwise manage message folders, such as email folders for spam messages, ham messages, bulk messages, inbox messages, deleted messages, or the like. In one embodiment, data storage 248 may also store and/or otherwise manage message classification data from traditional message filters. Moreover, in one embodiment, data storage 248 may further store one or more whitelists. In one embodiment, a whitelist might be configured for use in determining whether to allow a message sent to a primary message address to be delivered. In another embodiment, another whitelist might be configured for use in determining whether a message sent to a secondary message address, after “whitelist mode” is turned on, is to be allowed to be delivered to the secondary message address. However, multiple whitelists need not be used. For example, in yet another embodiment, a single whitelist might be used for messages sent to either primary messages addresses or secondary message addresses. In any event, at least a portion of the information may also be stored on a disk drive or other storage medium (not shown) within client device 200. In another embodiment, however, the whitelist(s) may be stored on a remote computer, such as network device 300.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, gmail, or the like. In another embodiment, messenger 243 may be a client application that is configured to integrate and employ a variety of messaging protocols. In one embodiment, messenger 243 may employ various message boxes or folders to manage and/or store messages.

In one embodiment, a user may employ messenger 243 and/or browser 245 to manage messages, create secondary message addresses, and/or place a block or unblock receipt of messages from a message sender address sent to a secondary message address for which the message sender address is not on a whitelist.

In another embodiment, the user may further employ messenger 243 and/or browser 245 to manage user feedback about a classification of one or more messages. For example, if the user determines that a message is improperly classified as spam, or non-spam, the user may modify a label, move the improperly classified message to another folder, or perform some other action, to modify the message classification. Such actions may then be used to selectively adjust a future classification of another message from a same message sender address.

### Illustrative Network Device Environment

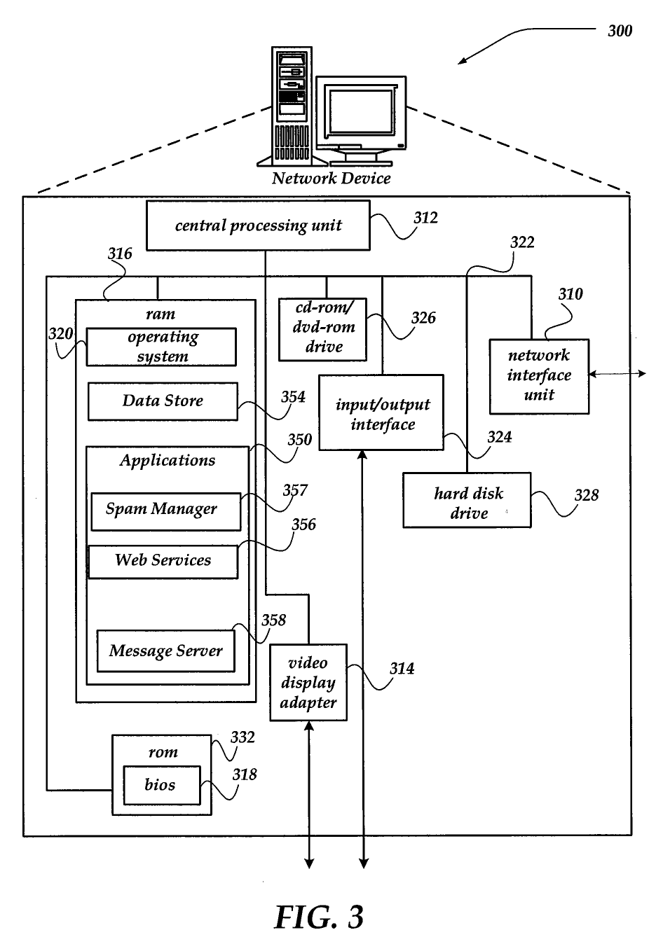

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, SDS 106 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer-readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other physical medium which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, contact lists, identifiers, profile information, tags, labels, or the like, associated with a user, as well as scripts, applications, applets, and the like. Data store 354 may also store one or more folders, inboxes, or other devices useable for storing and managing messages. Data store 354 may also be configured to store and/or otherwise manage one or more whitelists useable for primary message addresses, and/or secondary message addresses.

One or more applications 350 may be loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth. Applications 350 may include web services 356, Message Server (MS) 358, and message (spam) filters 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 may interact with spam manager 357 and/or message server 358 with respect to message classification.

Message server 358 may include virtually any computing component or components configured and arranged to forward messages from message user agents, and/or other message servers, or to deliver messages to a local message store, such as data store 354, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like.

However, message server 358 is not constrained to email messages, and other messaging protocols may be managed by one or more components of message server 358. Thus, message server 358 may also be configured to manage SMS messages, IM, MMS, IRC, mIRC, or any of a variety of other message types.

In one embodiment message server 358 is configured to enable a user to create one or more secondary message addresses. In one embodiment, messages received at a secondary message address may be sent to the user's primary message address's folders or other mechanism useable for receiving and/or managing messages.

Message server 358 is further configured to allow a user to create a whitelist of use in managing messages sent to a primary message address. However, the user is not constrained to using whitelists. Thus, for example, the user might select not to employ a whitelist for their primary message address. Thus, it is anticipated that their may be a plurality of primary messages addresses for which no whitelist is used, and another plurality of primary message addresses for which a whitelist is used.

Should the user select, therefore, to use a whitelist, the message server 358 may be used to automatically update the whitelist based, in part, on use of a secondary message address. Thus, the user may provide the secondary message address to one or more senders. When the sender communicates a message to the secondary message address, message server 358 will automatically, without additional actions by the user, update one or more whitelists with the sender's message address. In this way, the user need not manage their whitelists directly. However, should the user so select, they may be provided access to their whitelists for editing. For example, the user might select to positively add and/or delete a sender's message address, subdomain, or similar network address, to the whitelist for any of a variety of reasons.

Similarly, message server 358 may be configured to allow the user to turn on or off “whitelist mode” for one or more of their secondary message addresses. When “whitelist mode” is turned off, senders may send messages to the secondary message address and be added to one or more whitelists. When “whitelist mode” is turned on, messages from a sender's message address not currently on one or more of the user's whitelists would be rejected for delivery to the secondary message address. In one embodiment, if the sender's message address is on a whitelist, and is sent to the secondary message address, the user may further allow or disallow delivery of the message. Thus, a user may configure their secondary message addresses using a variety of different options. Such configuration settings may also be stored in data store 354.

In any event, information may be sent to spam manager 357 about whether a message is received and/or blocked based on a message being sent to a primary message address that does not have a whitelist, a message being sent to a primary message address that does have a whitelist, and a message being sent to a secondary message address that has “whitelist mode” on.

Spam manager 357 may, in another embodiment, receive the messages, employ message server 358 to determine whether a message is allowed or disallowed based on the above, and then obtain counts for the message sender addresses based on how the message was allowed or disallowed. Spam manager 357 therefore, might collect such count data for a plurality of different message recipients and/or potential message recipients, where the whitelists are based on a per message recipient basis.

Spam manager 357 may monitor the counts for the different categories of messages for a same message sender address. In another embodiment, spam manager 357 may monitor the counts for different categories of messages for message content deemed similar to each other, and/or similar to content previously determined to be spam. Spam manager 357 may compare the counts and/or combination of counts to different threshold values to determine whether the message sender address is determined to be a spammer or whether the messages with similar content are spam. Spam manager 357 may then mark or otherwise identify the message sender address as a spammer or the message as spam.

If the message sender address is determined to be a spammer, messages from the message sender address may be marked, labeled, and/or otherwise delivered to a spam folder for a designated message recipient. In another embodiment, if a message is determined to be spam, delivered messages and subsequent messages with similar content may be marked, labeled, and/or otherwise delivered to a spam folder for a designated message recipient. The recipient may then view the messages on their client device. The recipient may further modify a classification of a message by performing an action, such as moving the message to another folder, changing a label, tag, or other marking or identifier. Such actions may be received by spam manager 357 for use in modifying one or more thresholds used in evaluating the messages as spam or non-spam. Spam manager 357 may employ a process such as described below in conjunction with FIG. 4 to perform at least some of its actions. Furthermore, spam manager 357 and/or message server 358 may employ a process such as described below in conjunction with FIG. 5 to perform at least some of its actions.

Spam manager 357 may also include or access additional anti-spam filters, classifiers, or other tools to collect, analyze, and/or further evaluate a message. For example, spam manager 357 may enable content of a message to be analyzed to determine if the content indicates that the message is spam, or includes other improper content. Additionally, spam manager 357 may also employ one or more classifiers, or the like, to determine, based on content from one message whether another message includes substantially similar, or even matching content. Then based on the analysis, spam manager 357 may classify the other message as spam, or non-spam. However, spam manager 357 is not constrained to merely content and/or message sender addresses, and other aspects of a message may also be analyzed, including, but not limited to attachments, headers, size of a message, or the like, without departing from the scope of the invention.

### Generalized Operation

The operation of certain aspects of the invention will now be described with respect to FIGS. 4-5. FIG. 4 illustrates a logical flow diagram generally showing one embodiment of a process for employing primary and secondary message addresses in combination with a white list for a user to detect spam messages. Process 400 of FIG. 4 may be implemented within SDS 106 of FIG. 1, in one embodiment.

Process 400 begins, after a start block, at block 402 where a plurality of messages is received. In one embodiment, the messages are to be directed towards a plurality of different message recipients' message addresses. In one embodiment, the messages may be evaluated at this juncture using process 500 as described in more detail below in conjunction with FIG. 5. However, in another embodiment, the messages may be evaluated based on process 500 before received at block 402. In any event, process 500 may be employed to determine whether each message in the plurality of messages is to be allowed or disallowed for delivery to a designated recipient message address.

Thus, processing continues to block 404 where for each message from a same message sender address is evaluated such that counts may be determined at blocks 404a-404c. That is, at block 404a, a first count is determined as a number of messages sent from the same message sender address for which the messages are sent to a recipients' primary message addresses for which a whitelist is unemployed. Thus, the first count is across a plurality of different recipients' primary message addresses.

At block 404b, a second count is determined for the same messages for which the message is rejected based on a whitelist for a recipient's primary message address. Thus, if a recipient is employing a whitelist for their primary message address, the second count sums those messages rejected for failing to be on a whitelist. Again, the second count is across a plurality of different recipients' primary message addresses.

At block 404c, a third count is determined for the same messages for which the message is rejected based on a whitelist for a recipient's secondary message address. Recall that a message may be blocked from delivery to a recipient's secondary message address when the user has turned the status from “open mode” to “whitelist mode” for the secondary message address.

Thus, at the completion of blocks 404a-404c, three distinct counts of messages may be obtained. It is relevant to note that blocks 404a-404c, while illustrated as being performed concurrently, may also be performed sequentially. Thus, the invention is not limited to the sequence illustrated in FIG. 4.

Process 400 continues to decision block 406, where a determination is made whether the third count exceeds a third threshold value. If so, then processing flows to block 414; otherwise, processing flows to decision block 408.

At decision block 408, a determination is made whether the second count exceeds a second threshold value. If so, then processing flows to block 414; otherwise, processing flows to decision block 410.

At decision block 410, a determination is made whether the first count exceeds a first threshold value. If so, then processing flows to block 414; otherwise, processing flows to decision block 412.

At decision block 412, various combinations of the first, second, and/or third counts may be compared to different threshold values to determine if one or more of the various combinations exceed one of the different threshold values. If so, then processing flows to block 414; otherwise, processing flows to block 416.

It is noted that the thresholds may be set to a variety of different values based on analysis of historical data, statistical analysis, heuristics, engineering judgment, or the like. For example, in one embodiment, given a same number of occurrences for the above various categories of messages (from blocks 404a-404c), a probability of a message being spam may be expected to increase dramatically from normal (counts from block 404a), to primary (counts from block 404b) to secondary (counts from block 404c). By applying a pre-determined number of occurrences, and/or weights for each type of occurrence, spam detection may be tested for more quickly than by traditional approaches.

Thus, a message sender address may be determined as a spammer, and thus messages from the message sender address is marked as spam, in one embodiment, if the third count is greater than between about two to about four messages for the message sender address. In another embodiment, if the second count is determined to be greater than between about four to about eight messages, the message sender address may be marked as a spammer, and messages from the message sender address may be marked as spam. Similarly, if the first count is greater than between about eight to about 50 messages, then the message sender address may be marked as a spammer and messages from the message sender address may be marked as spam. In another embodiment, a count of each type of occurrence can be examined and compared to yet one or more other thresholds where the counts are based on content being substantially similar or identical, instead of and/or in addition to counts based on messages from a same message sender address. It should be noted, however, that the invention is not constrained to these example, non-limiting threshold values, and others may be selected.

As to a non-limiting, non-exhaustive example of a combination, in one embodiment, where the third count is greater than between about 1 and about 3, and the second count is greater than between about 2 and about 4, then the message sender address may be determined to be a spammer, and messages from the message sender address marked as spam. Similarly, the values and combinations of counts can be applied to occurrences of messages with identical or substantially similar content, in addition to and/or instead of based on messages from the same message sender address. Other values and combinations of counts of messages may also be used, without departing from the scope of the invention.

In any event, at block 416 the message with similar content or message sender address is marked, or otherwise identified as being a non-spam/non-spammer. Messages from the message sender address are further marked or otherwise identified as non-spam. In still another embodiment, messages may be selectively be forwarded to one or more other anti-spam filters, classifiers, or the like, to further analyze the message. Thus, messages labeled as non-spam by process 400, could still be reclassified as spam based on add analysis at block 416. In any event, processing then flows to block 418.

At block 414, the message sender address is marked, or otherwise identified as being a spammer. Messages from the message sender address are further marked or otherwise identified as spam. In addition, content from within the messages marked as spam may be collected, analyzed, and/or stored. Then, messages received that have matching, or substantially similar content as that collected from the spam messages, will also be marked as spam. Because it is recognized that a spammer may make minor changes in content, such as color changes, minor text changes, or the like, to confuse anti-spam detectors, a message analysis may be performed to determine if the content is sufficiently similar to the collected content to mark the message as spam. For example, substantially similar may be based on a statistical threshold that may be based on engineering judgment to balance Type I errors and Type II errors, obtain an acceptable confidence level, or other statistical criteria for defining content to be substantially similar. However, the invention is not limited to statistical analysis, and other approaches may also be used to define whether content being compared is substantially similar. For example, if the content is text, a percentage of matching content above a threshold value, may be used as defining substantially similar. In any event, if the message content in another message, independent of being from a same message sender address, is substantially similar, or even matching, then the other message is also marked as spam. In one embodiment, the message sender address for the other message may also be identified as a spammer. In any event, processing then flows to block 418.

At block 418, the messages from the message sender address may be selectively delivered to the one or more proposed recipients. In one embodiment, at least some of the messages identified as spam may be moved to a spam folder, or the like, for the proposed recipients. In another embodiment, a rule, policy, or the like, may indicate that for a given proposed recipient that spam is not to be delivered. In such instances, the spam may be deleted or otherwise redirected. Processing then may return to a calling process to perform other actions.

FIG. 5 illustrates a logical flow diagram generally showing one embodiment of a process for determining how to route a message to one of a primary or secondary message address. Process 500 of FIG. 5 may be implemented with SDS 106 of FIG. 1.

Process 500 begins, after a start block, at block 501, where a message is received for analysis. In one embodiment, the message may be from the plurality of messages obtained during block 402 of FIG. 4.

Processing then continues to decision block 502, where a determination is made whether the received message designates a primary message address for which it is to be delivered. If so, processing flows to decision block 504; otherwise, processing flows to decision block 511.

At decision block 504, a determination is made whether a whitelist is being used for the primary message address. If so, processing flows to decision block 508; otherwise, processing flows to block 506.

At decision block 511, a determination is made whether the message is for a secondary message address. If so, process 500 flows to decision block 512. Otherwise, the process branches to block 522, where the message address for the message is determined to not exist. Thus, at block 522, the message may be discarded. Processing then returns to a calling process to perform other actions.

At decision block 512, the message is determined to be directed to a secondary message address. As such, a determination at decision block 512 is made whether the secondary message address is turned on to blocking future or new message sender addresses (e.g. “whitelist mode” turned on). If so, then processing flows to decision block 508; otherwise, processing flows to block 514.

At decision block 508, a determination is made whether the message sender address associated with the message is on the whitelist. In one embodiment, a single whitelist may be used for both secondary and primary message addresses for the proposed recipient. However, in another embodiment, separate whitelists may be used, one for the primary message address, and one or more whitelists for the secondary message address(es) for the proposed recipient. In any event, if the message sender address in one of the whitelists, processing flows to block 506; otherwise, process branches to block 510.

At block 510, the message may be blocked or otherwise inhibited from being delivered to the message address. In another embodiment, however, the message may be labeled or otherwise identified as potential spam. In that embodiment, the message may still be delivered to the proposed recipient. However, the message may be delivered labeled as spam, and/or delivered to a spam folder, or the like. Processing flows to decision block 518.

At block 506, the message is selectively allowed to be delivered to the message address. That is, in one embodiment, the message may be further submitted to one or more additional anti-spam filters, analysis tools, or the like. For example, a classifier might be used to analyze content of the message to determine if the message includes spam, or other improper content. If the analysis determines that the message is spam, then the message might be marked as spam, and sent to a spam folder, in one embodiment. In another embodiment, the spam message may be sent to the recipient where the marking, label, tag, or the like, indicating that the message is spam is displayable to the recipient. In any event, processing flows to decision block 518.

At block 514, it is determined that no blocking of new message sender addresses is being employed for the secondary message address (e.g., “open mode” turned on). As such, the message sender address may be added to one or more whitelists. That is, if the message sender address is not currently on a whitelist for the primary message address for the proposed recipient, then the whitelist may be automatically updated to include the message sender address. Moreover, if there is a whitelist for the secondary message address, then that whitelist may also be updated with the message sender address.

Processing then flows to block 516, where the message may be delivered to the proposed message recipient. Processing continues to decision block 518, where a determination is made whether user feedback is received that indicates a message and/or the message sender address is to be reclassified. If not, then processing may return to a calling process to perform other actions. However, if so, then processing may flow to block 520, where the message sender address might be added (or deleted) from the whitelist based on the user feedback. Thus, if a message is delivered that should be classified as spam, but was not, then the user feedback might result in the message sender address as being removed from one or more whitelists, as appropriate. Similarly, if the message was improperly classified as spam, and was delivered, then the user feedback might add the message sender address to one or more whitelists. Processing also then returns to a calling process to perform other actions.

It is important to note, that while the above is described in the context of testing for managing messages from a given message sender address, the invention is not so limited. For example, the tests may also be based on a domain name, subdomain name, or the like. Thus, whitelists, for example, may include domain names, subdomain names, or the like, as well as or in place of a message sender address, without departing from the scope of the invention.

Moreover, at virtually any time, a user of a secondary message address may disable the secondary message address by selecting the option to block new message sender addresses (e.g., “whitelist mode” turned on) or all message sender addresses for messages sent to the secondary message address. In addition, the user may at virtually any time, edit one or more whitelists to add/delete and/or to modify its contents.

In addition, because a secondary message address may be configured to continue to receive messages after turning on “whitelist mode”, secondary message addresses provide at least one benefit, and therefore a difference over traditional disposable email addresses, where the email address may be disposed of or deleted, such that messages sent to the disposed of email address are all determined to undeliverable.

While counts of messages from a same message sender address may be employed to determine whether the message sender address is a spammer, and thus messages from the message sender address are spam, the invention is not so limited. Thus, as described above, content may also be analyzed to determine if a given sender is attempting to send spam messages using a different message sender addresses. Thus, content analysis may determine that messages from different addresses may still have identical or at least substantially similar content. Blocking and/or otherwise identifying messages based on content therefore may also be beneficial.

Therefore, in another embodiment, processes 400 and/or 500 may be expanded to spam based on content. For example, process 400 may determine a count of messages with substantially similar content regardless of message sender address for which the messages are sent to valid recipients' primary message address for which a white list is unemployed. Furthermore, similar to above, a count of messages may be determined with substantially similar content regardless of the messages sender address for which the messages are rejected based on a whitelist for a recipient's primary message address. In addition, a count of messages may be determined for messages with substantially similar content regardless of message sender addresses for which the messages are rejected based on being blocked from delivery to a recipient's secondary message address. Then a comparison may be performed to determine if one or more counts of messages or combinations of counts of messages exceed one or more different threshold values. If one or more of the different threshold values is exceeded, then the message may be marked such that a display of at least one such message is marked as spam at a client computer device. Moreover, in one embodiment, a combination of content analysis and message sender addresses may be performed for the detection of spam. Thus, embodiments enable a flexible variety of criteria to be employed.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems that perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A network device, comprising:
a transceiver to send and receive data over a network; and
a processor that is operative to perform actions, comprising:
receiving a plurality of messages;
determining a count of messages from a same message sender address for which the messages are sent to valid recipients' primary message addresses for which a whitelist is unemployed;
determining a count of messages from the same message sender address for which the message is rejected based on a whitelist for a recipient's primary message address;
determining a count of messages from the same message sender address for which the message is rejected based on being blocked from delivery to a recipient's secondary message address;
testing one or more of the determined counts of messages to determine if the one or more determined counts exceed selected threshold values; and
if one or more of the selected threshold values is exceeded marking the message sender address as a spammer, such that a display of at least one message from the marked message sender address is identified as spam at a client computer device.

2. The network device of claim 1, wherein the secondary message address is configured to employ a subdomain address, and wherein a message sent to the secondary message address is received at a same location as another message sent to a primary message address for the same message recipient.

3. The network device of claim 1, wherein the processor is operative to perform actions, further including:
determining another count of messages having substantially similar content independent of having the same message sender address for which the messages are sent to valid recipients' primary message address where the white list is unemployed;
determining another count of messages having substantially similar content independent of having the same message sender address for which the messages are rejected based on the whitelist for the recipient's primary message address;
determining another count of messages having substantially similar content independent of having the same message sender address for which the messages are rejected based on being blocked from delivery to the recipient's secondary message address;
comparing the other determined counts of messages or combinations of the other determined counts of messages against one or more other threshold values; and
if one or more of the other threshold values is exceeded, marking the messages such that a display of at least one such message is marked as spam at the client computer device.

4. The network device of claim 1, wherein the processor is operative to perform actions, further including:
receiving feedback as from a message recipient indicating whether the message recipient concurs that the message sender message is a spammer; and
modifying at least one of the selected threshold values based on the received feedback.

5. The network device of claim 1, wherein another message determined to have matching message content as the at least one identified spam message is also marked as spam.

6. The network device of claim 1, wherein another message sent to the recipient's secondary message address is received by the recipient, if a whitelist mode is turned off such that message blocking is turned off for the secondary message address; and
a message sender address associated with the other message is added to at least one of the whitelist associated with the recipient's primary message address or the recipient's secondary message address.

7. A processor readable storage medium that includes data and instructions, wherein the execution of the instructions on a computing device by enabling actions, comprising:
receiving a plurality of messages;
determining a count of messages from a same message sender address for which the messages are sent to at least one recipient's primary message addresses for which a whitelist is unemployed;
determining a count of messages from the same message sender address for which the message is rejected based on a white list for at least one recipient's primary message address;
determining a count of messages from the same message sender address for which the message is rejected based on being blocked from delivery to at least one recipient's secondary message address;
comparing the determined counts of messages or combinations of determined counts of messages against one or more threshold values; and
if one or more of the selected threshold values is exceeded, marking the message sender address as a spammer such that a display of at least one message from the marked message sender address is marked as spam at a client computer device.

8. The processor readable storage medium of claim 7, wherein the instructions enable actions, further comprising:
receiving user feedback regarding the marking of at least one message from the marked message sender address as spam; and
employing the received user feedback to modify one or more threshold values.

9. The processor readable storage medium of claim 7, wherein if at least one recipient's secondary message address is unblocked, then:
allowing messages to be received through the at least one recipient's secondary message address; and
placing the message sender addresses for the allowed messages onto a whitelist associated with the recipient's primary message address.

10. The processor readable storage medium of claim 7, wherein the plurality of messages comprises at least one of email messages, Short Message Service (SMS) messages, Multimedia Message Service (MMS) messages, instant messaging (IM) messages, or internet relay chat messages.

11. The processor readable storage medium of claim 7, wherein comparing the counts or messages further comprises comparing each determined count of messages to a different threshold, and if any one of the different thresholds are exceeded, marking the message sender address as a spammer.

12. The processor readable storage medium of claim 7, wherein another whitelist is employed for one of the recipient's secondary message address, and if the message sender address is on the white list for the one of the recipient's primary message address or the other whitelist for the one of the recipient's secondary message address, then not counting the message sender address in the determined count of messages for which the message is rejected based on being blocked from delivery by the one of the recipient's secondary message address.

13. The processor readable storage medium of claim 7, wherein being identified as spam further comprises displaying a label or moving the marked message to a spam folder.

14. A system for enabling a communications over a network, comprising:
a message server component residing in a network device that is configured to receive and send messages to a client device over the network; and
a spam manager component that is configured to reside on the network device or another network device, and to perform actions, including:
receiving a plurality of messages from the message server;
determining a count of messages from a same message sender address for which the messages are sent to at least one recipient's primary message addresses for which a whitelist is unemployed;
determining a count of messages from the same message sender address for which the message is rejected based on a white list for at least one recipient's primary message address;
determining a count of messages from the same message sender address for which the message is rejected based on being blocked from delivery to at least one recipient's secondary message address;
comparing the determined counts of messages or combinations of determined counts of messages against one or more threshold values; and
if one or more of the selected threshold values is exceeded, marking the message sender address as a spammer such that a display of at least one message from the marked message sender address is marked as spam at a client computer device.

15. The system of claim 14, wherein another message sent to the recipient's secondary message address is received by the recipient, if message blocking is turned off for the secondary message address; and
a message sender address associated with the other message is added to at least one of the whitelist associated with the recipient's primary message address or the recipient's secondary message address.

16. The system of claim 14, wherein the spam manager component is configured to perform actions, further including:
receiving feedback as from a message recipient indicating whether the message recipient concurs that the message sender address is a spammer;
receiving feedback from a message recipient indicating whether the message recipient concurs that the message is a spam; and
modifying at least one of the selected threshold values based on the received feedback.

17. The system of claim 14, wherein the plurality of messages comprises at least one of email messages, Short Message Service (SMS) messages, Multimedia Message Service (MMS) messages, instant messaging (IM) messages, or internet relay chat messages.

18. The system of claim 14, wherein at least one other message having content matching content within at least one message marked as spam is also marked as a spam message.

19. The system of claim 14, wherein being identified as spam further comprises displaying a label or moving the marked message to a spam folder.

20. The system of claim 14, wherein a selected threshold value used for the count of messages from the same message sender address or of messages with at least substantially similar content for which the message is rejected based on being blocked from delivery to at least one recipient's secondary message address about half as large of a numeric value as a selected threshold value for the determining a count of messages from a same message sender address for which the messages are sent to at least one recipient's primary message addresses.
